(19) United States
(12) Patent Application Publication
(10) Pub. No.: US 2015/0073790 A1
(43) Pub. Date: Mar. 12, 2015

(54) AUTO TRANSCRIPTION OF VOICE NETWORKS

(71) Applicant: Advanced Simulation Technology, inc. ("ASTi"), Herndon, VA (US)

(72) Inventors: Brendan STEUBLE, Great Falls, VA (US); Robert Butterfield, Reston, VA (US)

(21) Appl. No.: 14/480,388

(22) Filed: Sep. 8, 2014

Related U.S. Application Data
(60) Provisional application No. 61/875,176, filed on Sep. 9, 2013.

(51) Int. Cl. G10L 15/26

(52) U.S. Cl. CPC G10L 15/26
USPC 704/235

(57) ABSTRACT

The systems, methods, and devices of the various embodiments enable a transcription of voice communications to be provided in parallel with an audio recording of the voice communications.

### CROSS REFERENCE TO RELATED APPLICATIONS

This application claims the benefit of priority to U.S. Provisional Application No. 61/875,176 filed Sep. 9, 2013 entitled “Auto Transcription of Voice Networks,” the entire contents of which are hereby incorporated by 8reference.

### FIELD OF THE INVENTION

The present invention relates generally to the transcription of voice communications and more specifically to the transcription, in real time or near real time, of constrained voice communications and the output of the transcription as packets to a computer network.

### BACKGROUND

Recording voice communications (i.e., vocal utterances from one or more person) can provide an audio recording of the voice communications. A fundamental flaw in recording voice communications is that the audio recordings cannot be played intelligibly at arbitrary speeds. For example, a one minute audio recording of voice communications from a pilot cannot be completely replayed in a five second time period without speeding up the play rate of the audio recording such that the recorded voice communication is unintelligible. Another fundamental flaw in recording voice communications is that audio recordings cannot be directly searched.

### SUMMARY

The systems, methods, and devices of the various embodiments enable a transcription of voice communications to be provided in parallel with an audio recording of the voice communications. In an embodiment, a parallel stream of text packets, representing a transcription of an audio recording of a voice communication, may be sent to a network in parallel with audio packets of the audio recording. In an embodiment, the text packets may be directly searchable as text, may be used as semantic input to an artificial intelligence machine that reacts to a speech transmission, and/or may be played (e.g., displayed) at any arbitrary speed. In various embodiments, distributed and/or centralized processing may enable transcription of constrained voice communications in real time or near real time. Embodiment auto transcription methods, devices, and systems may integrate with existing visualization and debriefing assets using standard protocols. Embodiment auto transcription methods, devices, and systems may not require special hardware for each client and/or software changes to existing systems, but rather may operate in conjunction with hardware and software of existing systems. In an embodiment, auto transcription methods, devices, and systems may be tuned initially, for example on-the-fly as initially deployed, and may be re-tuned through use of data collection of domain specific voice communications. Embodiment auto transcription methods, devices, and systems may enable the display of the text of voice communications in exercise visualizations, the textual search of voice communications for key words; voice communications to be “fast-forwarded” intelligibly, and other benefits.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of an example automatic transcription device according to an embodiment.

FIG. 2 is a component block diagram of an embodiment system enabled to generate text packets from audio packets in real time or near real time.

FIG. 3 is a component block diagram illustrating another embodiment system enabled to generate text packets from audio packets in real time or near real time.

FIG. 4 illustrates an example system for converting audio data into audio packets for submission to a network.

FIG. 5 illustrates an example system for enabling third party equipment to submit audio packets to a network.

FIG. 6 is a process flow diagram illustrating an embodiment method for providing audio packets of a recorded voice communication and text packets of the transcription of the recorded voice communication in parallel.

FIG. 7 is a component block diagram of an example computing device suitable for use with the various embodiments.

FIG. 8 is a component block diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

As used herein, the term “computing device” is used to refer to any one or all of desktop computers, simulation and training computers, aircraft computers, personal data assistants (PDA's), laptop computers, tablet computers, smart books, palm-top computers, gaming controllers, and similar electronic devices which include a programmable processor and memory and circuitry for transcribing audio data.

The various embodiments are described herein using the term “server.” The term “server” is used to refer to any computing device capable of functioning as a server, such as a master exchange server, web server, mail server, document server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server type functionality that can be implemented on a computing device, such as laptop computer, thereby enabling it to function as a server (e.g., an enterprise e-mail server) only to the extent necessary to provide the functionality described herein.

As used herein the terms “auto transcription device” and “automatic transcription device” are used interchangeably to refer to a dedicated piece of hardware, such as a chip, computing device, etc., and/or a software application, such as a standalone application or module within an application, that includes a transcription engine enabled to transcribe audio data and generate text packets.

The systems, methods, and devices of the various embodiments enable a transcription of voice communications to be provided in parallel with an audio recording of the voice communications. In an embodiment, a parallel stream of text packets, representing a transcription of an audio recording of a voice communication, may be sent to a network in parallel with audio packets of the audio recording. In an embodiment, the text packets may be directly searchable as text, may be used as semantic input to an artificial intelligence machine that reacts to a speech transmission, and/or may be played (e.g., displayed) at any arbitrary speed. In various embodiments, distributed and/or centralized processing may enable transcription of constrained voice communications in real time or near real time. As used herein “real time” refers to data processing that occurs as the data is received, and “near real time” refers to data processing that occurs as the data is received with only minor temporary buffering that is not for long term data storage, such as minor temporary buffering of received data for purposes of accommodating communication delays, error correction, minimum data amounts needed for processing, etc. Real time and near real time processing differ from other types of processing in that received data is not first accumulated in a long term data store and then later retrieved from the long term data store for follow on processing by the processor when the processor is available. Rather, in real time and near real time processing the processor may be unable to delay processing the data, and must handle the data as it is actually received or with only minor temporary buffering. Embodiment auto transcription methods, devices, and systems may integrate with existing visualization and debriefing assets using standard protocols. Embodiment auto transcription methods, devices, and systems may not require special hardware for each client and/or software changes to existing systems, but rather may operate in conjunction with hardware and software of existing systems. In an embodiment, auto transcription methods, devices, and systems may be tuned initially, for example on-the-fly as initially deployed, and may be re-tuned through use of data collection of domain specific voice communications. Embodiment auto transcription methods, devices, and systems may enable the display of the text of voice communications in exercise visualizations, the textual search of voice communications for key words; voice communications to be “fast-forwarded” intelligibly, and other benefits.

In an embodiment, initial tuning of a transcription engine may be performed using a collection of audio recordings of appropriate voice communications. The collection of audio recordings of appropriate voice communications may be domain specific thereby enabling the transcription engine to be tailored to identify a constrained set of words and phrases associated with the environment in which the voice communications occur. For example, in a flight simulation domain audio recordings of past in flight voice communications and a constrained set of words and phrases for flight training may be used to tune the transcription engine to identify the constrained set of words and phrases likely to occur in the flight simulation domain. As another example, in addition to the audio recordings and constrained words and phrases being field of endeavor specific, such as flight simulation domain specific, the audio recordings and constrained words and phrases may also be location specific. For example, the constrained words and phrases may be location specific, by including the call signs, latitudes, longitudes, and landmarks associated with a specific airport to be used for flight training in the constrained words and phrases. The tuning of the transcription engine to a domain specific constrained set of words and phrases may enable the transcription engine to correctly identify words and phrases within audio data of recorded voice communications with a higher accuracy (or lower error rate) than a transcription engine which is not tuned to recognize a domain specific constrained set of words and phrases. The domain specific tuned transcription engine may achieve a higher accuracy rate because a limited number of words and phrases may be present in the constrained set of words and phrases and the words and phrases used by speakers may be limited because of the nature of the domain. For example, air traffic controllers may use only a limited number of words and phrases to guide airplanes, and a domain specific tuned transcription engine may use the constrained set of words and phrases to more identify words and phrases within audio data of recorded voice communications from air traffic controllers with a high accuracy (or low error rate). Additionally, the transcription engine may be tuned to a specified accuracy (or word error rate), such as a customer specified accuracy rate. Further, tuning of the transcription engine to a domain specific constrained set of words and phrases may enable the transcription engine to more quickly identify and transcribe words than a transcription engine which is not tuned to recognize a domain specific constrained set of words and phrases.

In an embodiment, the tuned transcription engine may receive voice communication inputs and process all voices identified in real time or near real time. Voice communications may be originated by a human speaking, a recording, or some other sound output mechanism that may generate sound waves received by a microphone that may cause the microphone to generate an analog voltage. Additionally, received radio signals may include representations of voice communications, and a radio receiving the radio signals may generate analog voltages representing the voice communications in response to receiving the radio signals. In an embodiment, the voice input may be constrained to the particular domain or application that the transcription engine was tuned to recognize, for example voice inputs in a commercial aviation setting. Constraining the voice inputs to the particular domain or application that the transcription engine is tuned to recognize may ensure correct functioning of the transcription engine. Use of the transcription engine in a different domain than the transcription engine is tuned for may cause the specified accuracy (or word error rate) not to be achieved because the words or phrases used in the different domain may not correspond the words or phrases in the collection of audio recordings of appropriate voice communications for the particular domain used to tune the transcription engine. Through the use of analog to digital converters, the analog electrical signals of the voice communication generated by the microphone (or radio) may be converted to a digital signal at a sampling rate. Any sampling rate and/or bits per sample setting may be used, as long as the resulting digital audio signal may be recognized as human speech when played. The audio data may be assembled into audio packets. Any method for assembling the audio packets and any format of the audio packets may be used in the various embodiments, as long as the data in the packets may be used to recreate the audio data to a level of accuracy such that the resulting audio signal recovered from the audio data may be recognizable as human speech and that the speech recognized corresponds within a tolerance to the original voice communication received by the microphone (or radio).

In an embodiment, the auto transcription device may receive every audio packet, or a copy of every audio packet, and may transcribe each audio packet as received. In an embodiment, the received audio packets may be arranged by originator and audio data may be generated using the audio packets upon receipt by the auto transcription device. The transcription engine may receive the audio data and transcribe the audio data into text. The text may be assembled into text packets and the auto transcription device may output the text packets or the text packets and the audio packets. For example, the auto transcription device may send the text packets and audio packets to a device connected to a network, such as the Internet, a training and simulation network, etc. In this manner, the same voice recording may be sent as audio packets of audio data of the voice communication and text packets of text of the voice communication in parallel, for example at the same time or within some set period of each other (e.g., a time delay), such as within 0.5 second, 0.75 seconds, 1.00 second, 1.5, seconds, etc. of each other. For example, the audio packets of the audio data of the voice communication and the text packets of the text of the voice communication may be sent over the network from the processor in near real time (e.g., within a time delay, such as a time delay of a few seconds). The time delay may depend and/or account for a time to accumulate a semantic content and a minor transcription processing delay. A semantic content may be an extracted meaning of the speech, which may be stored in a structured format, such as key-value pairs. The time to accumulate the semantic content may be a time required to accumulate all of the words that make up an intelligible phrase and to select a correct word based on its surrounding context. In an embodiment, a semantic content may be sent in the text packets of the text of the voice communication along with the raw speech text. The inclusion of the semantic content in the may enable external system receiving the text packets of the voice communication not to need to perform natural language parsing on the raw text themselves, because these external systems may use the semantic content already in the received text packets.

In an embodiment, the text packets may include additional metadata related to the transcription of the audio data of the voice communication, such as the originator of the voice communication, start time of the voice communication, accuracy, etc.

In an embodiment, the transcription engine may be tuned while in operation. As an example, an operator may manually monitor the transcription of the audio data as it occurs and identify and correct mistakes in the transcription. The input from the operator identifying and correcting the mistakes may be fed back into the transcription engine and used to tune the transcription engine while in operation. As an example, an operator may listen to the audio data of a military training exercise in which an operator said “Fire the UAV”, but the transcription engine transcribed the audio data as “Fire the save.” The operator may identify the error of the transcription engine in outputting “save” vice “UAV”, and edit the text to say “Fire the UAV.” These edits may be fed back to the transcription engine to enable the transcription engine to better identify “Fire the UAV” the next time the phrase is spoken. In an embodiment, the transcription engine may be re-tuned at any point by adding additional collections of audio recordings of appropriate voice communications and constrained words and phrases to the transcription engine. The additional collection of audio recordings and constrained words and phrases of appropriate voice communications may be domain specific thereby enabling the transcription engine to be further tailored to the environment in which the voice communications occur. In an embodiment, the additional collection of audio recordings and constrained words and phrases of appropriate voice communications may come from use of the auto transcription device itself. In this manner, though a less than ideal tuning of the transcription device may have occurred initially, for example from the use of a only tangentially related words and phrase set, repeated use of the auto transcription device may enable the transcription engine to be tuned to the domain it is operated in.

The generation of text packets in parallel with audio packets may enable text of voice communications to be displayed and/or searched and/or used as semantic input to artificial intelligence machines. The text packets may enable real time visual display of the text of voice communications and/or may enable display of the text of voice communications as part of after action reports. As an example, the text of voice communications may be displayed as part of a website archiving the voice communications. The display of the voice communications as text may enable the voice communications to be searched for key words and the content of the voice communication may be consumed by a user as quickly as the user may read the displayed text. As another example, the text of voice communications may be used by an artificial intelligence machine, e.g., a robot, user interface, intelligent agent, etc., that reacts to speech transmissions. Additionally, the transcription of audio packets may occur at any point in a network, such as at the device receiving the voice communication (e.g., a headset, etc.) and/or at other devices in a network. As an example, an auto transcription device may be plugged into a radio to transcribe all voice traffic passing through the radio.

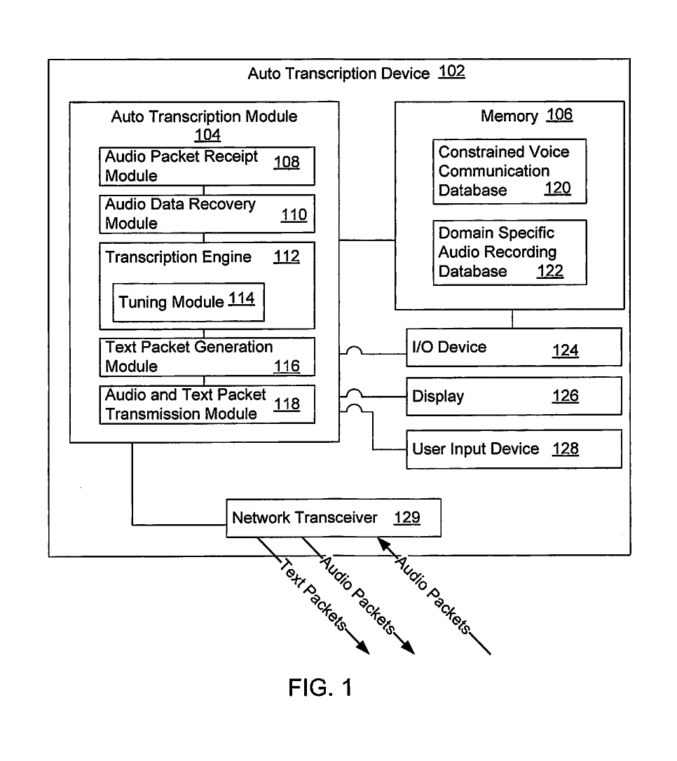

FIG. 1 illustrates an example automatic transcription device 102 according to an embodiment. The auto transcription device 102 may be any type device, such as a standalone device dedicated to auto transcription, or a device performing various other functions in addition to auto transcription, such as a laptop computer or server configured to perform auto transcription as discussed herein. The automatic transcription device 102 may include an auto transcription module 104, memory 106, and network transceiver 129. The auto transcription module 104 and the memory 106 may be in communication and configured to exchange data. The auto transcription module 104 and the network transceiver 129 may be in communication and configured to exchange data. The automatic transcription device 102 may also include an input/output device 124, such as a CD-ROM drive, USB port, etc., a display 126, and a user input device 128, such as a key board, mouse, touch pad, etc. The input/output device 124 may be in communication with the auto transcription module 104 and/or the memory 106 and configured to exchange data with the auto transcription module 104 and/or the memory 106. The user input device 128 and display 126 may be in communication with the auto transcription module 104 and configured to exchange data with the auto transcription module 104.

The auto transcription module 104 may include various sub-modules, such as an audio packet receipt module 108, audio data recovery module 110, transcription engine 112, text packet generation module 116, and an audio and text packet transmission module 118. The audio packet receipt module 108 may receive audio packets from the network transceiver 129, may group the audio packets by originator, and may provide the received audio packets to the audio data recovery module 110. The audio recovery module 110 may use the audio packets to recover audio data and provide the audio data to the transcription engine 112. The transcription engine 112 may apply various algorithms to transcribe the audio data into text. The transcription engine 112 may include a tuning module 114 which may use a constrained voice communication database 120 stored in the memory 106 and a domain specific audio recording database 122 stored in the memory 106 to tune the transcription engine 112. Tuning using the databases 120 and 122 in memory 106 may be performed initially before the transcription engine 112 transcribes text, and/or as part of a re-tuning process performed after initial transcription. The tuning module 114 may also output text as it is transcribed to the display 126 and monitor indications of user input from the user input device 128 while transcription is occurring. In this manner, “on the fly” while the transcription engine 112 is in operation, the tuning module 114 may receive indications from an operator via the user input device identifying errors in the transcription and providing corrections. The error identifications and corrections may be used by the tuning module 114 to tune the transcription engine 112 as they are received, thereby enabling tuning of the transcription engine 112 in operation. The transcription engine 112 may send the text of the audio data to the text packet generation module 116 which may generate text packets and send the text packets to the audio and text packet transmission module 118. The audio and text packet transmission module 118 may send the text packets and/or the audio packets and the text packets to the network transceiver 129 to be sent to a network.

As discussed above, the memory 106 may include a constrained voice communication database 120 and a domain specific audio recording database 122. The constrained voice communication database 120 may be a limited set of words and phrases that may be domain specific. The domain specific audio recording database 122 may be a collection of past recordings of audio data that is specific to the domain in which the automatic transcription device 102 may operate. These databases 120 and 122 may be updated with additional audio recordings and additional constrained voice communications (e.g., additional words and phrases) via transmission from the network via the network transceiver 129 and/or input from the input/output device 124.

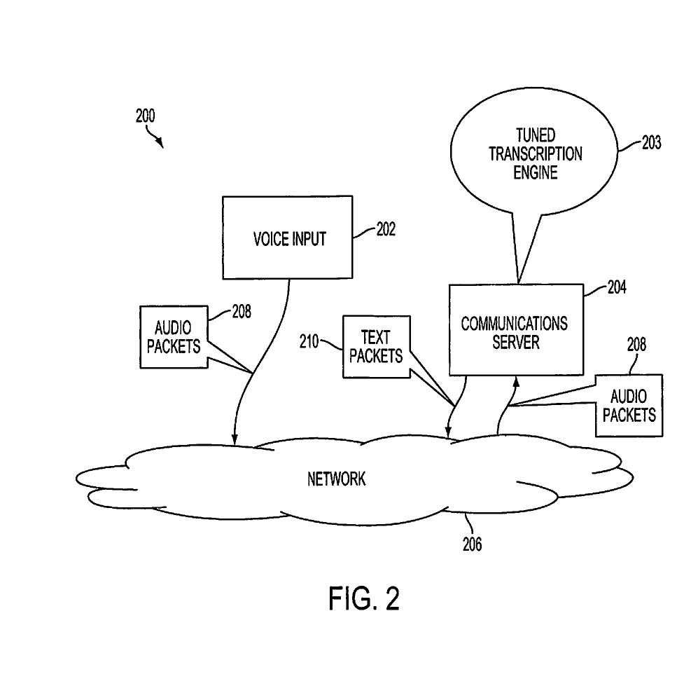

FIG. 2 illustrates an embodiment system 200 enabled to generate text packets from audio packets in real time or near real time. A voice input 202 may output audio packets 208 to a network 206. The audio packets 208 may be received by a communications server 204 including a tuned transcription engine 203. Using the tuned transcription engine 203 text packets 210 may be generated from the audio packets 208 and sent from the communications server 204 to the network 206.

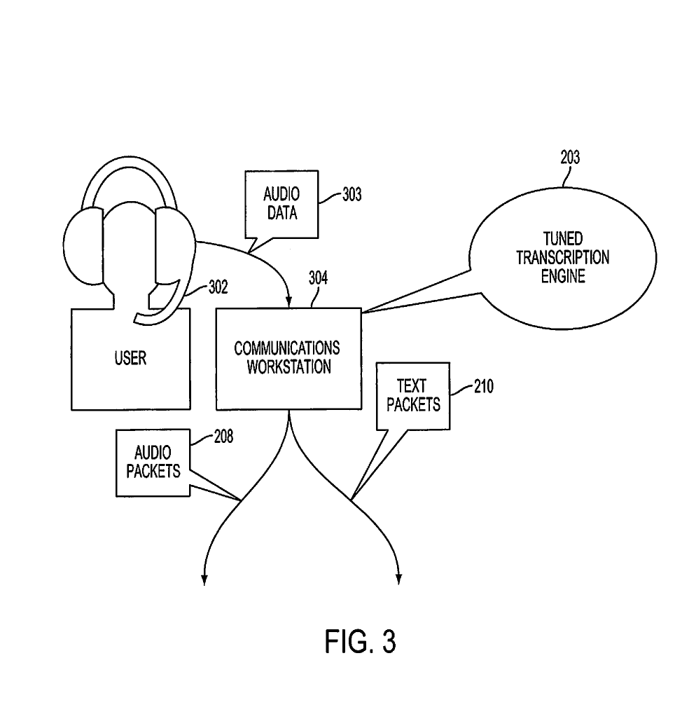

FIG. 3 illustrates another embodiment system 300 enabled to generate text packets from audio packets in real time or near real time. A user's headset 302 may generate audio data 303. The audio data 303 may be sent to a communications workstation 304 including a tuned transcription engine 203. Using the tuned transcription engine 203, text packets 210 and audio packets 208 may be generated at the communications workstation 304 and output from the communications workstation 304 in parallel, for example to a network.

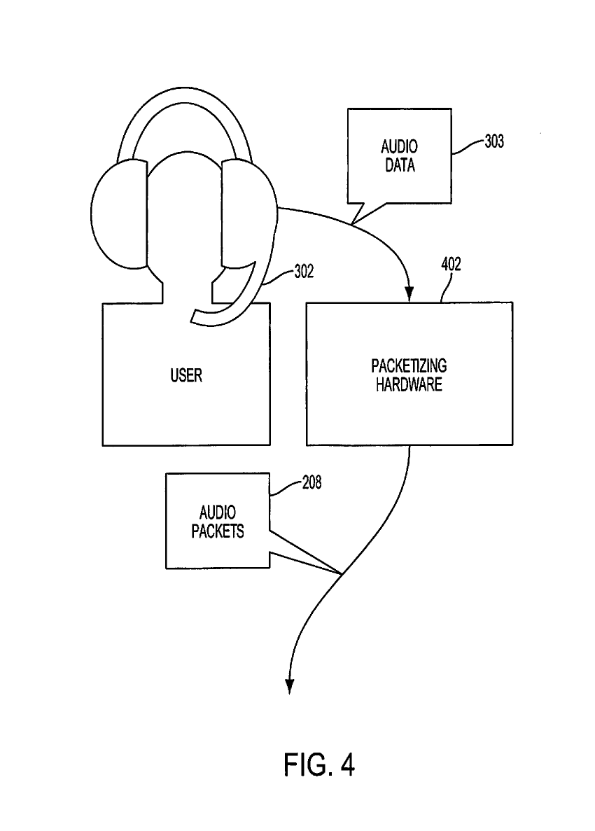

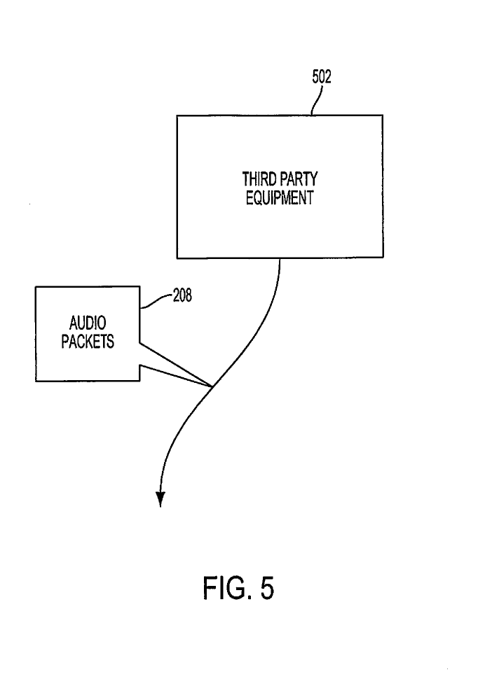

FIG. 4 illustrates an example system 400 for converting audio data into audio packets for submission to a network. A user's headset 302 may generate audio data 303. The audio data 303 may be sent to packetizing hardware 402 that may generate and output audio packets 208 from the audio data 303. FIG. 5 illustrates an example system 500 enabling third party equipment 502 to generate and submit audio packets 208, for example to a network.

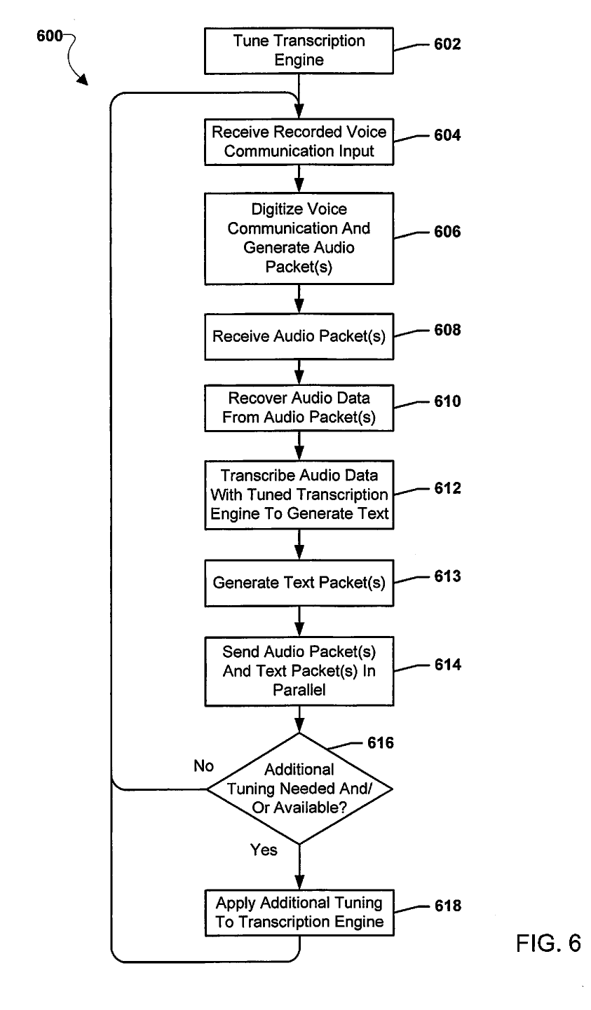

FIG. 6 illustrates an embodiment method 600 for providing audio packets of a recorded voice communication and text packs of the transcription of the recorded voice communication in parallel. In an embodiment, the operations of method 600 may be performed by the processor of a computing device, such as an auto transcription device. In another embodiment, the operations of method 600 may be performed by the processors of more than one device connected to a network. In block 602 the transcription engine may be tuned. In an embodiment, the transcription engine may be tuned with domain specific audio recordings and a domain constrained limited set of words and phrases. As an example, in an air traffic control domain the transcription engine may be tuned with past recordings of air traffic control voice communications and a constrained list of the words and phrases likely to be used in air traffic control voice communications, such as internationally recognized commands and the designations of runways and/or flights for a specific airport. In block 604 a recorded voice communication input may be received. For example, the recorded voice communication input may be an analog recording of speech picked up by an air traffic controller's or pilot's headset microphone or an air traffic control radio. In block 606 the voice communication may be digitized and one or more audio packets may be generated.

In block 608 the audio packet or packets may be received and in block 610 the audio data may be recovered from the audio packet or packets. For example, the audio packets may be decoded and error correction may be applied to recover the audio data within the audio packets. In block 612 the speech within the audio data may be transcribed by the tuned transcription engine to generate text (e.g., text data) corresponding to the speech within the audio data. In block 613 the text may be used to generate one or more text packet. In an embodiment, each text packet may correspond to one of the one or more received audio packets. In block 614 the text packet or packets and the audio packet or packets may be sent in parallel, for example at the same time or within a specified time, such as one second, of each other. For example, the text packet or packets and the audio packet or packets may be sent in parallel over a network, such as the Internet, to one or more visualization and debriefing asset, such as a computing device having a display and speakers. In this manner, the visualization and debriefing asset may receive the text packet or packets and the audio packet or packets and may use the text packet or packets to display a textual representation of the speech in the audio data recovered from the text packet or packets and/or audibly play out an audio representation of the speech in the audio data recovered from the audio packet or packets. As another example, the text packet or packets and the audio packet or packets may be sent in near real time, usually within a time delay of one another (e.g., within a few seconds of each other) dependent on the time to accumulate a semantic content and a minor transcription processing delay, to an artificial intelligence machine that reacts to the speech within the text packet or packets. In this manner, the artificial intelligence machine may operate as an intelligent agent that reacts to voice communications, by processing the transcribed speech in the text packet or packets which may be more accurate that the artificial intelligence machine itself attempting to process the received audio. In an embodiment, the semantic content may be included in the text packet or packets, for example in a structure format, such as a key-value pair. The inclusion of the semantic content in the text packet or packets may enable external systems to avoid needing to perform natural language processing on the raw speech in the text packet or packets.

In determination block 616 it may be determined whether additional tuning of the transcription engine is needed and/or available. For example, when an operator is present and reviewing the transcription an indication of an error and/or a correction in the transcription input by the operator may indicate additional tuning is needed. As another example, additional domain specific audio recordings and/or additional domain constrained limited sets of words and phrases may be loaded into a memory which may indicate additional tuning is needed or available. In response to determining that additional tuning is not available (i.e., determination block 616 =“No”), the method 600 may return to block 604 and continue to transcribe audio packets with the initially tuned transcription engine. In response to determining that additional tuning is available/needed (i.e., determination block 616=“Yes”), in block 618 additional tuning may be applied to the transcription engine and the method 600 may return to block 604 and transcribe audio packets with the retuned transcription engine.

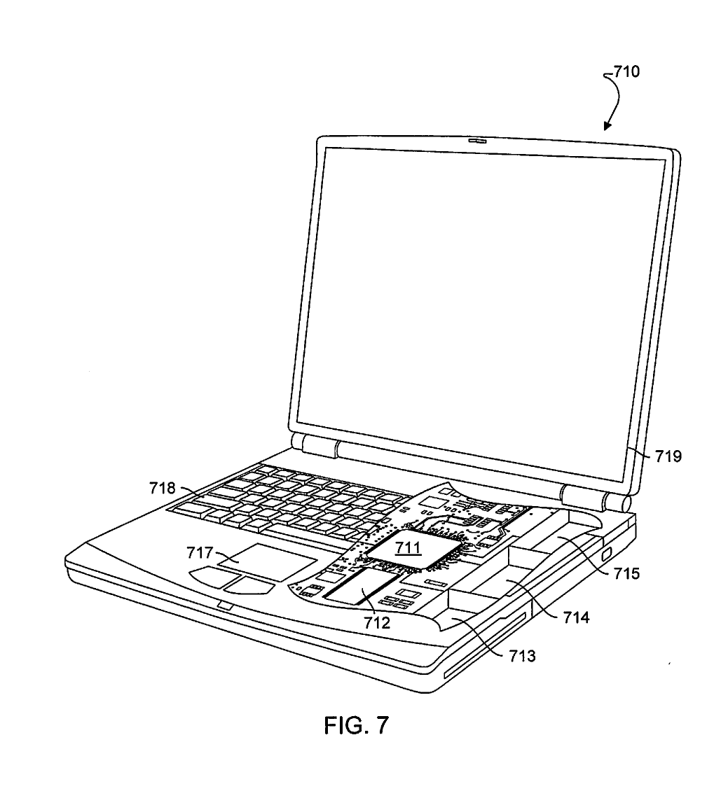

The various embodiments described above may be implemented within a variety of computing devices, such as a laptop computer 710 as illustrated in FIG. 7. Many laptop computers include a touch pad touch surface 5717 that serves as the computer's pointing device, and thus may receive drag, scroll, and flick gestures similar to those implemented on mobile computing devices equipped with a touch screen display and described above. A laptop computer 710 will typically include a processor 711 coupled to volatile memory 712 and a large capacity nonvolatile memory, such as a disk drive 713 of Flash memory. The laptop computer 710 may also include a floppy disc drive 714 and a compact disc (CD) drive 715 coupled to the processor 711. The laptop computer 710 may also include a number of connector ports coupled to the processor 711 for establishing data connections or receiving external memory devices, such as a USB or FireWire® connector sockets, or other network connection circuits (e.g., interfaces) for coupling the processor 711 to a network. In a notebook configuration, the computer housing may include the touchpad 717, the keyboard 718, and the display 719 all coupled to the processor 711. Other configurations of the computing device may include a computer mouse or trackball coupled to the processor (e.g., via a USB input) as are well known, which may also be use in conjunction with the various embodiments.

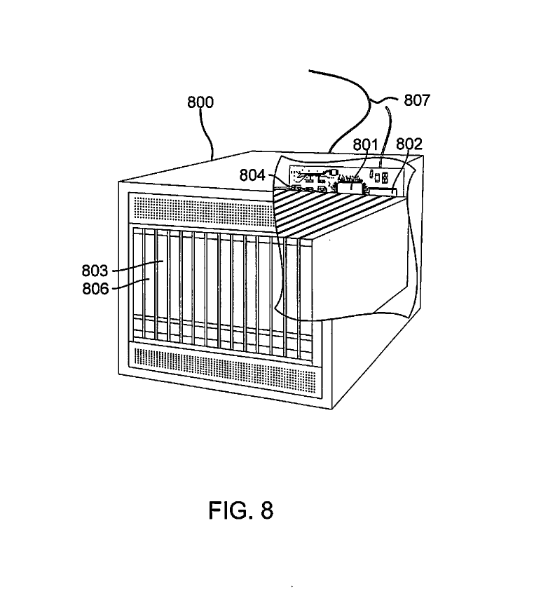

The various embodiments may also be implemented on any of a variety of commercially available server devices, such as the server 800 illustrated in FIG. 8. Such a server 800 typically includes a processor 801 coupled to volatile memory 802 and a large capacity nonvolatile memory, such as a disk drive 803. The server 800 may also include a floppy disc drive, compact disc (CD) or DVD disc drive 806 coupled to the processor 801. The server 800 may also include network access ports 804 (network interfaces) coupled to the processor 801 for establishing network interface connections with a network 807, such as a local area network coupled to other computers and servers, the Internet, the public switched telephone network, and/or a cellular data network, etc.

The processors 711 and 801 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 711 and 801. The processors 711 and 801 may include internal memory sufficient to store the application software instructions. In many devices the internal memory may be a volatile or nonvolatile memory, such as flash memory, or a mixture of both. For the purposes of this description, a general reference to memory refers to memory accessible by the processors 711 and 801 including internal memory or removable memory plugged into the device and memory within the processor 711 and 801 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, comprising:
receiving, in a processor, audio data packets of a voice communication;
recovering audio data from the received audio data packets;
transcribing speech within the audio data using a transcription engine executing within the processor to generate text corresponding to the speech within the audio data; and
sending the audio data packets and the corresponding text over a network from the processor.

2. The method of claim 1, wherein:
transcribing speech within the audio data using a transcription engine executing within the processor to generate text corresponding to the speech within the audio data comprises transcribing speech within the audio data using a tuned transcription engine executing within the processor to generate text corresponding to the speech within the audio data; and
the tuned transcription engine executing within the processor is tuned with domain specific audio recordings and a domain constrained set of words and phrases.

3. The method of claim 2, wherein the tuned transcription engine executing within the processor is tuned with domain specific audio recordings and a domain constrained set of words and phrases to achieve a specified accuracy.

4. The method of claim 2, further comprising generating text packets corresponding to the audio data packets from the generated text using the tuned transcription engine executing within the processor, and
wherein sending the audio data packets and the corresponding text over a network from the processor comprises sending the audio data packets and the corresponding text packets over a network from the processor.

5. The method of claim 4, wherein the audio data packets and corresponding text packets are sent over the network from the processor at the same time.

6. The method of claim 4, wherein:
transcribing speech within the audio data using the tuned transcription engine executing within the processor to generate text corresponding to the speech within the audio data and generating text packets corresponding to the audio data packets from the generated text using the tuned transcription engine executing within the processor occur in real time or near real time;
the audio data packets and corresponding text packets are sent over the network from the processor within a time delay of each other; and
the time delay is dependent on a time to accumulate a semantic content and a minor transcription processing delay.

7. The method of claim 2, further comprising:
tuning the transcription engine executing in the processor while the transcription engine is in operation based at least in part on comparing text generated by the transcription engine with corresponding portions of the voice communication.

8. The method of claim 2, further comprising:
re-tuning the transcription engine executing in the processor with additional domain specific audio recordings and an additional domain constrained set of words and phrases.

9. An auto transcription device, comprising:
a network interface; and
a processor connected to the network interface, wherein the processor is configured with processor-executable instructions to perform operations comprising:
receiving audio data packets of a voice communication;
recovering audio data from the received audio data packets;
transcribing speech within the audio data using a transcription engine to generate text corresponding to the speech within the audio data; and
sending the audio data packets and the corresponding text over a network via the network interface.

10. The auto transcription device of claim 9, wherein the processor is configured with processor-executable instructions to perform operations such that:
transcribing speech within the audio data using a transcription engine to generate text corresponding to the speech within the audio data comprises transcribing speech within the audio data using a tuned transcription engine to generate text corresponding to the speech within the audio data; and
the tuned transcription engine is tuned with domain specific audio recordings and a domain constrained set of words and phrases.

11. The auto transcription device of claim 10, wherein the processor is configured with processor-executable instructions to perform operations such that the tuned transcription engine is tuned with domain specific audio recordings and a domain constrained set of words and phrases to achieve a specified accuracy.

12. The auto transcription device of claim 10, wherein the processor is configured with processor-executable instructions to perform operations further comprising generating text packets corresponding to the audio data packets from the generated text using the tuned transcription engine, and,
wherein sending the audio data packets and the corresponding text over a network via the network interface comprises sending the audio data packets and the corresponding text packets over a network via the network interface.

13. The auto transcription device of claim 12, wherein the processor is configured with processor-executable instructions to perform operations such that the audio data packets and corresponding text packets are sent over the network via the network interface at the same time.

14. The auto transcription device of claim 12, wherein the processor is configured with processor-executable instructions to perform operations such that:
transcribing speech within the audio data using the tuned transcription engine to generate text corresponding to the speech within the audio data and generating text packets corresponding to the audio data packets from the generated text using the tuned transcription engine occur in real time or near real time;
the audio data packets and corresponding text packets are sent over the network via the network interface within a time delay of each other; and
the time delay is dependent on a time to accumulate a semantic content and a minor transcription processing delay.

15. The auto transcription device of claim 10, wherein the processor is configured with processor-executable instructions to perform operations further comprising:
tuning the transcription engine executing while the transcription engine is in operation based at least in part on comparing text generated by the transcription engine with corresponding portions of the voice communication.

16. The auto transcription device of claim 10, wherein the processor is configured with processor-executable instructions to perform operations further comprising:
re-tuning the transcription engine with additional domain specific audio recordings and an additional domain constrained set of words and phrases.

17. A non-transitory processor readable storage medium having stored thereon processor-executable instructions configured to cause a processor to perform operations comprising:
receiving audio data packets of a voice communication;
recovering audio data from the received audio data packets;
transcribing speech within the audio data using a tuned transcription engine to generate text corresponding to the speech within the audio data, wherein the tuned transcription engine is tuned with domain specific audio recordings and a domain constrained set of words and phrases; and
sending the audio data packets and the corresponding text over a network.

18. The non-transitory processor readable storage medium of claim 17, wherein the stored processor-executable instructions are configured to cause a processor to perform operations such that the tuned transcription engine is tuned with domain specific audio recordings and a domain constrained set of words and phrases to achieve a specified accuracy.

19. The non-transitory processor readable storage medium of claim 17, wherein the stored processor-executable instructions are configured to cause a processor to perform operations further comprising generating text packets corresponding to the audio data packets from the generated text using the tuned transcription engine, and
wherein the stored processor-executable instructions are configured to cause a processor to perform operations such that:
transcribing speech within the audio data using the tuned transcription engine to generate text corresponding to the speech within the audio data and generating text packets corresponding to the audio data packets from the generated text using the tuned transcription engine occur in real time or near real time; and
sending the audio data packets and the corresponding text over a network comprises sending the audio data packets and the corresponding text packets over a network at the same time or within a time delay of each other, wherein the time delay is dependent on a time to accumulate a semantic content and a minor transcription processing delay.

20. The non-transitory processor readable storage medium of claim 17, wherein the stored processor-executable instructions are configured to cause a processor to perform operations further comprising re-tuning the transcription engine with additional domain specific audio recordings and an additional domain constrained set of words and phrases.
